(19) United States
(12) Patent Application Publication
(10) Pub. No.: US 2022/0202035 A1
(43) Pub. Date: Jun. 30, 2022

(54) SWEETENER AND SWEETENED PRODUCTS

(71) Applicant: Sweet Ninja Foods Limited, Long Crendon, Aylesbury (GB)

(72) Inventors: Gareth Patrick Dunne, Long Crendon, Aylesbury (GB); Gregory Morris Combs, Long Crendon, Aylesbury (US)

(73) Assignee: Sweet Ninja Foods Limited, Long Crendon, Aylesbury (GB)

(21) Appl. No.: 17/608,395

(22) PCT Filed: May 4, 2020
(86) PCT No.: PCT/GB2020/000045

§ 371 Date: Nov. 2, 2021

(30) Foreign Application Priority Data
May 2, 2019 (GB) 1906156.3

(51) Int. Cl. A23G 1/48; A23G 1/00; A23L 19/15; A23G 1/40; A23G 1/46; A23L 33/125; A23L 29/30

(52) U.S. Cl. CPC A23G 1/48; A23G 1/0026; A23G 1/0053; A23L 19/15; A23G 1/40; A23G 2200/14; A23L 33/125; A23L 29/30; A23G 2200/08; A23G 2200/12; A23G 1/46

(57) ABSTRACT

A food sweetener is a powder having an average particle size of, at most, 1,500 μm and including pulverized dried fruit, vegetables or both fruit and vegetables. The powder, on a dry basis, has at least 30% wt and at most 70% wt of total sugars, and has a moisture content of from 1 to 6% by weight. Chocolate products may incorporate the powder and a method for producing the power is taught.

### FIELD OF THE INVENTION

The present invention relates to sweeteners and to sweetened products such as chocolate, chocolate coatings and various dessert and bakery products.

### BACKGROUND TO THE INVENTION

The invention is concerned with products which are sweetened with fruit and/or vegetable or a blend of the two with or without protein, i.e. wherein the conventional sweetening component, typically being processed sugar, has been replaced by a sweetening ingredient that is obtained from fruit and/or vegetable or a blend of the two. The invention also relates to the sweetening ingredient itself and its use in the manufacture of chocolate. The invention relates to, inter alia, chocolate containing fruit and/or vegetables and blends thereof with or without protein. The chocolate product according to the invention is chocolate of a type containing, in a relatively large amount, at least one kind of super dehydrated fruit and/or super dehydrated vegetable fibre/powder which has been pulverised and dispersed in a chocolate base in place of any and all processed sugar. Herein this ingredient shall be referred to as “Wholesweet™”. Wholesweet™ is not made from extracted fruit sugar which is 100% sucrose but from the whole of the fruit and/or vegetable which contains sucrose, glucose, fructose enzymes, vitamins, minerals and other micronutrients.

When used herein, the term “chocolate” covers chocolate in all its forms and uses and includes all grades from fine chocolate to simple and economical chocolate coatings and the like.

Producing a chocolate product containing natural ingredients where the processed sugar is replaced with fruit, has, proved to be a challenge for chocolate processing companies. The addition of a fresh fruit, which contains a high level of water to chocolate has been proven to be impracticable since the two components do not combine with each other. If not impossible, only a very limited amount of fresh fruit can be incorporated in chocolate so that the resulting “fruit chocolate” lacks the taste and odour of the incorporated fruit and also requires a significant level of other sweetening agents. Therefore, fruity flavourings have generally been utilised to produce fruit-flavoured chocolates with fruity odours/aromas. These products still comprise processed sugar or sugar substitutes. GB 2065442 is an example of chocolate with some fruit and processed sugar and other additives.

It is known to combine dried or candied fruit with chocolate thereby to increase the fruit-to-chocolate proportion to a level sufficient to afford the product with a fruity taste. Examples of conventional chocolate products based on this concept are chocolate-coated dried fruits and a class of fruit chocolates produced by moulding a chocolate paste which contains grains or crushed pieces of a dried fruit dispersed therein. In these chocolate products, however, the presence of the grains or crushed pieces of dry fruit is perceptible and, when eaten, the tongue will detect a physical variance between the fruit inclusions and the smoothness of chocolate itself. The fruit additions do not act to replace, in whole or in part, the processed sugar (sucrose) in the chocolate recipe.

It is desirable that a dehydrated fruit be uniformly mixed and dispersed in the chocolate, to become “chocolate of fruit” or “chocolate of vegetable” rather than chocolate with fruit or chocolate with vegetable. Hitherto, however, this has proved difficult to produce for the following reasons.

Dried fruits are lower in water content than fresh or raw fruits, but they still contain considerable amounts of water in comparison with chocolate. Also, they contain saccharides, polysaccharides and pectic substances and, hence, exhibit stickiness. Therefore, when a dehydrated fruit or crushed pieces thereof are added to chocolate base at the stage of adding other ingredients during a conventional fine chocolate manufacturing process, the resulting mixture scarcely assumes a state of dough. Even where a dough-like state is reached, refining of the dough-like mixture by roll refiners causes the dehydrated fruit to be squeezed into a sticky jelly-like phase. As this jelly-like, phase incorporates other ingredients such as powdered milk, sticky agglomerates are produced which can be reduced in size only with difficulty, thereby making refining difficult to achieve. Even if refining can be achieved by greatly decreasing the proportion of dehydrated fruit to chocolate, there is a further problem that the succeeding conching process (stirring or mixing the chocolate for an extended period of time) becomes impracticable. During conching the pieces of dehydrated fruit in the chocolate paste adhere to one another, incorporate hydrophilic materials such as sugar and powdered milk and/or absorb moisture, with the result that grains or coarse particles are formed in the paste. If the conching process is further continued, these grains or coarse particles agglomerate into larger heaps, which tend to separate from the fat in the paste and solidify in the conching apparatus, sometimes with the possibility of damaging the apparatus.

In another possible manufacturing method, the fruit is pulverised into such small particles, in advance of mixing it with the chocolate base, that physical variance in the fruit chocolate produced may not be detectable by the tongue. However, such pulverization of any dehydrated fruit is practically impossible by means of a conventional mill due to sticking of crushed pieces of the fruit to parts of the mill such as the blades. Even if the pulverization is forcibly accomplished, the result is that the treated dry fruit is formed into agglomerates of a sticky paste-like or jelly-like substance which cannot be uniformly dispersed in a chocolate paste.

It is known that a material which exhibits stickiness at room temperature may be pulverized in a frozen state. Dehydrated fruits can be pulverized by this technique, but the pulverized fruits remain in the form of small particles only while they are in the frozen state. As the temperature of the particles rises to room temperature or above, the particles soften and adhere to one another and finally turn into sticky or jelly-like agglomerates of considerably large sizes. It is impossible to disperse a dehydrated and freeze-pulverized dehydrated fruit in a chocolate paste with the maintenance of the finely pulverized form of the fruit.

The use of extracted fruit sugar has been contemplated. The sugar component from a fruit is separated from the other components of the fruit (protein, fibre, etc) and usually “concentrated into a fruit or molasses e.g., date nectar, agave nectar. These fruit sugar extracts are sticky and very difficult to dry into a free-flowing powder, preferring to fractionate into a syrup or gum-like substance which cannot be used in the manufacture of chocolate.

GB2065442 discloses a method of producing a chocolate with fruit. The method gives a type of fruit chocolate that contains at least one kind of dehydrated fruit in finely pulverized and substantially uniformly dispersed state and in an amount that the product has sufficiently strong taste and odour of the contained fruit.

Example 5 of GB 2065442 describes a fruit chocolate which does not contain refined sugar or any sugar substitute but has a good and sufficiently strong sweetness of fruits and odour. The chocolate containing fruit was produced by the steps of mixing dried dates and raisins with cacao mass, freezing the resulting mixture at a sufficiently low temperature; pulverizing the frozen mixture into fine particles; and mixing the fine particles with a separately prepared chocolate base, resulting in a chocolate paste which contains the fine particles in substantially uniformly dispersed state, followed by shaping of the paste into products. The manufacturing process of GB 2065442 is still rather complex. The dried fruit is first mixed with a significant amount of cacao mass and then pulverized in the frozen state. This powder is subsequently mixed with a chocolate base that needs to be prepared separately and of which the recipe must be suitably adapted for later accommodating the powder which also includes a cacao mass portion.

The product produced in Example 5 of GB2065442 only contains a minor portion of the three types of sugars, namely, sucrose, glucose and fructose, and therefore a very minor portion of the micronutrients of wholefood, including but not limited to enzymes, vitamins and minerals.

### SUMMARY OF THE INVENTION

According to the present invention, there is provided a powder of dried fruit and/or vegetable powder and/or blends thereof (Wholesweet™), a fine chocolate and/chocolate coating product comprising this powder, and two production methods thereof, as well as, the uses thereof.

According to a first aspect of the present invention, there is provided a powder comprising pulverised dried fruit and/or vegetable, the powder having an average particle size of at most 1500 μm, characterised in that the powder comprises, on a dry basis, at least 30% wt and at most 70% wt of total sugars and having a moisture content of from 1 to 6% by weight.

Preferably, the moisture content is up to 5%, more preferably up to 2%.

Preferably, the average particle size of the powder is at most 95 μm. Preferred upper limits for the average particle size are 90 μm, 80 μm, 75 μm, 70 μm, 60 μm, 50 μm, 40 μm, 35 μm, 30 μm and 25 μm.

Preferably, 90% of the particles have a particle size of no more than 300 microns.

Maintaining an average particle size below 100 μm brings the advantage of a better mouth feel, in particular a smoother mouth-feel. Preferably the majority of the particles in the powder are smaller than the tongue can detect, particularly for fine chocolate.

A smaller average particle size may allow the option to skip the conching step as part of the production process of the chocolate product.

In the traditional method for producing chocolate and chocolate-like products, the ingredients are mixed and milled in a refiner or mill to reduce the particle size of the solids. The paste resulting from this “refining step” is then conched in a “conche”, typically a container filled with metal beads which act as grinders. Conching is a flavour expanding and smoothing step which involves the intimate mixing or kneading of the chocolate ingredients and is traditionally carried out at elevated temperatures, the chocolate mass being kept in a liquid state by the frictional heat generated during the process. Conventional chocolate prior to conching has an uneven and gritty texture. The conching process produces cocoa and sugar particles smaller than the tongue can detect, hence the smooth feel in the mouth. During conching, the flavour of the product expands and develops and the desired viscosity, final texture and mouthfeel are obtained. Typically, the free acid and water content of the chocolate further dissipate are reduced during the conching process.

Conching is a time-consuming and energy intensive step in the chocolate manufacturing process and typically takes from a few hours to a few days, depending on the product and the equipment used. The length of the conching process typically determines the final smoothness and quality of the chocolate. High-quality chocolate may be conched for as long as 72 hours, lesser grades about 4 to 6 hours. After conching, the product is typically liquefied by heating up to 45-50° C. and tempered as the ultimate processing step. Being able to eliminate the conching step from the production process brings a significant simplification of the process and enables a significant saving of production time and energy consumption, in addition to savings on investment costs.

The chocolate product of the invention is preferably free of processed/refined Sugar and of any sugar substitutes. It contains a much wider nutritional profile and may be produced using equipment and techniques used in conventional chocolate manufacturing methods although in simpler overall processes.

Preferably the chocolate product is free of any of the known artificial bulk sweeteners, including isomaltooligosaccharide, oligosaccharide, maltitol, sorbitol, xylitol, erythritol, and/or isomalt. Advantageously, the chocolate product may, if so desired, also be free of dairy ingredients, of gluten, of other allergens, of soy, of starch, and/or of palm oil. If desired, the chocolate product can also be free of lecithin or other emulsifiers. The chocolate product is preferably a natural product with a “wholefood” ingredient profile. It can be a good source of nutritional fibre, a clean ingredient deck and is virtually indistinguishable from conventional chocolate. The product can be manufactured to be vegan and contain protein if so desired.

Preferably, the powder further comprises at least one element from the group consisting of a protein, a dietary fibre, a pectic substance, and a carbohydrate other than sugars.

Preferably, fructose represents at least 6% wt of the total sugars, on a dry basis, is fructose.

Preferably, at most 80% wt of the total sugars, on a dry basis, is sucrose.

Preferably, the dried fruit and/or vegetable is selected from the group consisting of raisins, i.e. dried grapes, dried dates, dried pitted dates, dried figs, dried prunes, dried beets, and dried bananas. More preferably, the dried fruit and/or vegetable are sun-dried dates.

According to a second aspect of the present invention, there is provided a chocolate product comprising a chocolate base and, on a dry basis, at least 15% wt and at most 40% wt of the powder product of the invention.

Preferably, the chocolate product comprises, on a dry basis, at least 10% wt and at most 45% wt of the powder of the invention.

Preferably, the chocolate product comprises, at least 18% wt and at most 35% wt of cocoa fat/butter and/or equivalents.

Preferably, the chocolate product comprises, based on the total amount of dry matter, at least 15% wt and at most 75% wt of chocolate solids and/or chocolate liquor.

Preferably, the chocolate particles in the chocolate solids and/or chocolate liquor have an average particle size of at most 95 μm, preferably at most 90 μm, more preferably at most 80 μm, even more preferably at most 75 μm, yet more preferably at most 70 μm, preferably at most 60 μm, more preferably at most 50 μm, even more preferably at most 40 μm, preferably at most 35 μm, more preferably at most 30 μm, even more preferably at most 25 μm.

Respecting the upper limit for the average particle size of the chocolate further contributes to the advantage of a better mouth feel, in particular a smoother mouth-feel. Preferably the majority of the particles in the chocolate ingredient are smaller than the tongue can detect. This feature also increases the likelihood of being able to omit the conching step, with the advantages that have already been described above.

Preferably, the chocolate product comprises, based on the total amount of dry matter, at least 5% wt and at most 25% wt of dairy and/or non-dairy milk powder.

The chocolate product may be, for instance, a chocolate categorised as a dark chocolate or a milk chocolate.

Where the milk powder is a non-dairy milk powder in which case it is preferably soy milk, rice milk or coconut milk.

The chocolate product may include an emulsifier such as lecithin or a lecithin substitute, preferably sunflower lecithin.

The chocolate product may include a flavouring, for instance, vanilla powder.

The chocolate product may include particles, having an average particle size in the range of at least 500 μm, of a member of the group consisting of nuts, dried fruits, dried vegetables and plant protein.

According to a third aspect of the present invention, there is provided a process for the production of the powder of the invention, the process comprising the steps of:
(a) Providing fruit and/or vegetable containing, on a dry basis, at least 40% wt and at most 70% wt of total sugars;
(b) Reducing the moisture content of said fruit and/or vegetable to from 1 to 6% by weight; and
(c) Milling the product of step (b) at a temperature in the range of 0−50° C. to obtain a powder having an average particle size of at most 1500 μm.

As will be well understood by those skilled in the art, the mixing step is dependent on the manufacturing output desired: 1) fine chocolate: or 2) coatings and the like.

The dried sweet fruit and/or vegetable produce selected for the present invention may be milled or milled at a temperature in the range of 0-50° C. There is no need for freezing the dried fruit, such as in GB 2065442. There is also no need for including extra components in the material that is milled or milled over and above the dried fruit, such as the 30 parts of cacao mass in Example 5 of GB 2065442. All these extra precautions and extra complexities may be eliminated from the process for producing the powder according to the present invention.

Preferably, the milling of the dried sweet fruit and/or vegetable produce is performed at a temperature of at most 40° C., preferably at most 20° C. Respecting this upper limit on the milling temperature reduces the risk that the substance that is being milled would start to caramelize and end up becoming sticky.

Preferably, the process in step (b) is performed by vortex milling, more preferably in a jet mill or an air mill.

According to a fourth aspect of the present invention, there is provided a process for the production of a chocolate product of the invention comprising the steps of
(a) Providing the powder of the invention;
(b) Mixing the powder of step (a) with chocolate solids and/or liquor to form a tempering feed, whereby the chocolate particles in the chocolate solids and/or chocolate liquor have an average particle size of at most 100 μm; and
(c) Tempering the tempering feed from step (b) to form a tempered chocolate product.

Other ingredients may be added in step (b) including cocoa butter and/or equivalent fat, but without any processed sugar.

Further ingredients which may be added in step (b) including one or more of a protein, a dairy and/or non-dairy milk powder, an emulsifier, in particular, lecithin or a lecithin substitute, preferably soy lecithin, a flavouring, for instance, vanilla powder and particles, having an average particle size in the range of at least 500 μm, of nuts, for instance, hazel nuts, dried fruits, dried vegetables.

Preferably, the process further comprising the step of shaping the tempered chocolate product into an object.

According to a fourth aspect of the present invention, there is provided the use of the powder of the invention for sweetening a chocolate product.

According to a fifth aspect of the present invention, there is provided the use of the chocolate product of the invention for forming a shaped chocolate product such as a chocolate bar, a chocolate product containing fruit and/or nut and or candy inclusions and combinations thereof. The shaped product may be formed by, for instance, a method selected from extrusion, moulding, forming, depositing and combinations thereof.

According to a sixth aspect of the present invention, there is provided the use of the chocolate product of the invention for providing the coating of a coated chocolate product.

In the production of the powder of the invention, the treatment, which may include milling, grinding and/or drying, of the dried fruit and/or vegetables is such that the powder of the invention may be made at ambient temperature.

The powder of the invention can be produced without the powder becoming sticky, i.e. while maintaining the product of the milling and/or grinding step as a free-flowing powder.

The powder of the invention benefits from the nutritional properties of wholefoods. Processed and refined sugars have been stripped of many components that are naturally found in fruit and vegetables (three types of sugar, fibre, carbohydrates, protein, ash, micro-nutrients, etc). These additional and materially nutritious components enable the desired capability of grinding/milling/drying the raw material such that a powder is created having the particle size as specified without causing processing problems, and without having to rely on freezing the raw material and/or grinding in the presence of a significant amount of cacao mass.

The characteristics of the powder according to the present invention, when used as sweetener for a chocolate coating, enable a significant simplification of the production process for the chocolate coating. The powder according to the present invention may readily be incorporated into the other ingredients for the chocolate product, and that this incorporation may be performed by simple mixing, i.e. without the need for any high shear mixing equipment, for a homogenizer. This allows for the production of a chocolate coating; fine chocolate will continue to be made using a conching step.

The powder according to the present invention comprises at least 40% wt of total sugars. Accordingly, the powder is able to perform its intended function as a sweetener for foodstuffs without requiring excessively high levels in the recipe of the foodstuff, and, furthermore, is in line with normal processed sugar levels in most forms of chocolate.

Examples in accordance with the present invention will now be described.

### EXAMPLE 1

### Dried Date Powder: 100% Wholesweet™

Fresh dried dates of the varieties Deglet Nour and Sukkari are harvested, pitted and sun dried in crates in the full desert sunshine for up to 3 weeks.

To produce Wholesweet™, and when these dates have a moisture level <10% they are milled through a hammer mill to produce a coarse, gritty, slightly sticky granular product.

This material is spread on to large stainless steel trays, in a bed approximately 1 cm deep and lightly baked at <65° C. for 4 hours. The coarse dry powder is then hammer milled again, and the process is repeated, with the material spread onto stainless steel trays, 1 cm deep and baked at 50° C. for 4 Hours. Following this process, a final milling is carried out with the addition of a 1 mm sieve to the outlet of the hammer mill. This resulting powder has a moisture level of <5%, but ideally less than 2.5%, The final particle size and distribution was evaluated using a Malvern instruments Mastersizer 2000 and results were as follows;

Table showing particulate size distribution of Coarse Wholesweet™

| Particle Size | | | | | | | | | | |
|---|---|---|---|---|---|---|---|---|---|---|
| and | 50- | 107- | 213- | 301- | 426- | 501- | 712- | 1001- | 1401- | 2001- |
| Distribution | 106 | 212 | 300 | 425 | 500 | 710 | 1000 | 1400 | 2000 | 2800 |
| (μm) | μm | μm | μm | μm | μm | μm | μm | μm | μm | μm |
| Percentage | 11.9 | 28.8 | 8.8 | 10.8 | 4.9 | 12.7 | 11.3 | 8.4 | 1.9 | 0.5 |
| of sample | | | | | | | | | | |
| (%) | | | | | | | | | | |

This resultant Wholesweet™ is the principal ingredient used in all other product and process EXAMPLES below.

Further milling of this product allows the formulation of very fine powder with an average particle size of <15 microns. In this process the milled date powder mixture is further processed by passing the course particles through a 200LS-N Air Jet Sieve & Multi-processor (AFG/ZPS) Mill, allowing the manufacture of a range of ‘microfine’ date powder having an average particle size of, in the first trial 500 microns, the second trial 100 microns, the third trial, 50 microns and in the final trial the average particle size was 15 microns. This powder was further processed in EXAMPLE 5.

Wholesweet™ is gluten free, dairy free, vegetarian and vegan. It can be used to replace processed sucrose as an ingredient in numerous products including chocolate and chocolate products. Unlike processed sugar, which is essentially a nutrient poor but extremely high calorie bleached sucrose derived from sugar cane or sugar beet, through a highly industrialised energy intensive process, Wholesweet™ contains a complex set of 3 sugars, fructose, glucose and sucrose. Wholesweet™ also contains a source of fibre and proteins as well as vitamins and minerals.

Wholesweet™ was then used for the preparation of chocolate products as a direct replacement for processed sugar (see below). Wholesweet™ was also used in the preparation of bakery and biscuit products, and its use in formulations of hot/cold powdered drinks and other foodstuffs, such as spreads (fruit, nut or chocolate), desserts, yoghurts, toppings, inclusions, bakery products, baby food, confectionary, ice cream, and a wide range of various non specified food stuffs that contain processed sugar.

Wholesweet™ Blends™

Numerous Wholesweet™ blends have been created and more are envisioned. Two examples are detailed below:

Date/Carrot Blend

Fresh carrots with a moisture level of 88% were sliced and convection dried for 5 hours @ 75° C. They were then milled to 1,500 microns and convection dried for another 5 hours @ 75° C. A third drying was performed for two hours @ 75° C. with the output then milled to an average particle size of 1500 microns. The resultant powder had a moisture level of <5%, ideally, 2.5%.

Date Wholesweet™ was then blended with the carrot powder in a ratio of 90:10 and used in place of processed sugar in the production of EXAMPLE 4.

Date/Raisin

Dried raisins with a moisture level of 18% were minced and then convection oven dried for 5 hours @ 75° C. These were then milled to an average particle size of 3,000 microns and convection dried for another 5 hours @ 75° C. A third drying was performed for two hours @ 75° C. with the output then milled to an average particle size of 1,000 microns.

Date Wholesweet™ was then blended with the raisin powder in a ratio of 80:20 and used in place of processed sugar in the production of both dark and milk chocolate.

Alternatively, 100% raisin powder was used in place of processed sugar in the production of both dark and milk chocolate. This method can also be used with sultanas in place of raisins.

Banana/Carrot

Dried bananas with a moisture level of 12% were sliced, then convection dried for 4 hours @ 75° C. These were then milled to 3,000 microns and convection oven dried for a further 3 hours @ 75° C. A third drying was performed for two hours @ 75° C. with the output then milled to an average particle size of 1,500 microns, with a moisture content of <5% or ideally <2.5%.

Date Wholesweet™ was then blended with the dried banana powder in a ratio of 70:30 and used in place of processed sugar in the production of EXAMPLE 4.

Alternatively banana powder was used 100% in place of processed sugar in the production of both dark and milk Chocolate.

Wholesweet™/Protein Powder

Date Wholesweet™ was blended with (Whey) Protein powder in a ratio of 90:10 and used in place of processed sugar in the production of both dark and milk Chocolate of Example 5.

### EXAMPLE 2

70% Cocoa Solids Dark Chocolate with Date Wholesweet™

An example formulation for a 70% cocoa solids plain (Dark) gluten free, dairy free, no added sugar plain chocolate product is described as follows.

Melt 34.7% cocoa liquor and 35.19% cocoa butter, add 29.33% Wholesweet™ powder and 0.39% sunflower lecithin and 0.39% vanilla. This chocolate can be prepared using the conventional processes of refining, milling then tempering the final product, or can be manufactured using the alternative method described in EXAMPLE 5. The resultant chocolate can be tempered and deposited into moulds, used as a coating for enrobing purposes or can be pan coated onto other ingredients such as nuts, fruits or other candy centres.

This chocolate output would contain approximately a third less sugar and 2 times more fibre and protein than conventional chocolate, with the date powder also contributing further vitamins and minerals which are not present in processed sugar.

### EXAMPLE 3

55% Cocoa Solids Non Dairy or Milk Chocolate with Date Wholesweet™ An example formulation for a 55% cocoa solids non-dairy milk gluten free, no added sugar chocolate is described as follows. Melt 31.81% cocoa liquor and 22.86% cocoa butter, add 34.79% Wholesweet™ powder and 9.94% rice milk powder. Add 0.4% sunflower lecithin and 0.2% vanilla. This chocolate can be prepared using the conventional processes of refining, milling then tempering the final product, or can be manufactured using the alternative method described in EXAMPLE 5. The resultant chocolate can be tempered and deposited into moulds, used as a costing for enrobing purposes or can be pan coated onto other ingredients such as nuts, fruits or other candy centres.

This chocolate output would contain approximately a third less sugar and 2 times more fibre than conventional chocolate, with the date powder also contributing further vitamins and minerals which are not present in processed sugar.

### EXAMPLE 4

32% Cocoa Solids Chocolate with Date/Vegetable Wholesweet™ Blends™ An example formulation for a 32% cocoa solids non-dairy milk gluten free, no added sugar vegetable chocolate is described as follows. Melt 24.71% cocoa liquor and 27.18% cocoa butter, add vegetable Wholesweet™ this contributes 10.3% carrot Wholesweet™ powder and 29.24% Wholesweet™ powder to the formulation, and 8.24% rice milk powder. Add 0.33% sunflower lecithin. This chocolate can be prepared using the conventional processes of refining, milling then tempering the final product, or can be manufactured using the alternative method described in EXAMPLE 5. The resultant chocolate can be tempered and deposited into moulds, used as a costing for enrobing purposes or can be pan coated onto other ingredients such as nuts, fruits or other candy centres.

This chocolate output would contain approximately a third less sugar and 2 times more fibre than conventional chocolate, with the date powder and dried vegetable powder also contributing further vitamins and, minerals which are not present in processed sugar.

### EXAMPLE 5

### New Simple Manufacture Method for Chocolate Containing Wholesweet™ as a Replacement for Processed Sugar

The human mouth cannot identify particles with a size below approximately 20 microns. The current process to manufacture fine chocolate involves reducing the size of the ingredients particles to a size smaller than that which the human mouth can perceive, and dispersing these in cocoa butter. This is done by taking all of the dry chocolate ingredients, cocoa nibs, sugar, milk powder and ‘refining’ them, by passing them through a series of roller mills where the ‘gap’ between the rollers of the mill is sequentially reduced to result in a chocolate dough with an average particle size of <15 microns. This delivers a smooth, velvety chocolate, where no ‘grittiness’ is perceived in the human mouth upon eating. The chocolate consumer expects fine chocolate to deliver this smooth, velvety mouthfeel when they purchase a retail bar of chocolate. Refining and conching chocolate is an energetic, time consuming and expensive process requiring specialist machinery.

### EXAMPLE 6

### Baked Traditional Shortbread Biscuit Containing NO Processed Sugar Manufactured Using Wholesweet™

An example formulation for a baked traditional shortbread biscuit containing no processed sugar is described as follows.

Beat 125 g of butter and 65 g of date Wholesweet™ together until smooth. Stir in 180 g of plain flour to get a smooth paste. Turn on to a work surface and gently roll out until the paste is 1 cm thick. Cut into fingers 5 cm long and chill in the fridge for 20 minutes. Bake in a preheated oven at 190 C for 15-20 minutes or until golden brown in colour.

This biscuit contains approximately a third less sugar and 2 times more fibre and protein than conventional shortbread biscuits, with the date powder also contributing further vitamins and minerals which are not present in processed sugar.

### EXAMPLE 7

### A Compound Coating Used to Coat Baked Goods and Biscuits Using Wholesweet™

An example formulation for a compound coating used to coating baked goods and biscuits containing no processed sugar is described as follows. Mix equal parts of water, melted cocoa butter and Wholesweet™. Stir vigorously until mixture comes together. Add natural flavourings and/or natural colourings. Pour resultant coating onto flapjacks, cookies, cakes or biscuits.

This coating contains approximately two thirds less sugar and 2 times more fibre and protein than conventional compound coatings, with the date powder also contributing further vitamins and minerals which are not present in processed sugar.

The examples described above in EXAMPLES 2 and 3 have been manufactured using conventional methods in a modern chocolate processing facility. The manufacturing methods used for their manufacture generally required the mixing of the cocoa liquor, coarse Wholesweet™ powder (average particle size 1,500 microns), non-dairy milk powder (rice flour), then refining these products through a chocolate refiner. Further processing of this material using a chocolate conch, where the chocolate dough is mixed for a number of hours to develop flavour notes. Other flavourings such as vanilla and/or salt can be added at this stage. This process results in a final “fine chocolate” product and has an average particle size of 15 microns.

In this example a new processing method has been developed which does not require the use of chocolate refiners or a conch.

In this new and simple production process the cocoa liquor and cocoa butter are heated to 45° C. with constant stirring. When melted, 100% coarse Wholesweet™ or a coarse Wholesweet™ Blend was added in place of processed sugar, (see EXAMPLE 1). If manufacturing a milk chocolate product, non-dairy milk powder can be added at this stage along with lecithin and flavours. The extremely small particle size of the date powder (<15 microns), greatly aids the perception of a smooth and velvety chocolate product without the requirement of refining or conching. This chocolate processing step has been developed to produce relatively inexpensive ‘course’ chocolate product ideal for coating products such as biscuits or cereal bars which already contain inclusions and crumbs, or for pan coating fruit and nuts and does not require the use of expensive machinery such as a refiner or conch.

### Additional Manufacturing Formulations

In addition to the formulations outlined above in EXAMPLES 2-5, it is also envisioned that these formulations and variations thereof could be further modified by adding finely milled plant protein powder such as soya protein, sunflower protein and/or pea protein. This would allow for the production of vegan chocolate with the added benefit of additional protein, which helps senescence, (feeling fuller for longer), and aids muscle repair following exercise. The addition of protein can take place either when the conventional chocolate manufacturing processes are carried out and when the methods outlined in EXAMPLE 5 is used.

Further products which may be made, using one or more aspects of the present invention, include:

Moulded Tablet products, moulded and spun shapes (e.g. chocolate eggs), Injection moulded products containing both water and fat based centres, Pan coated products, other coatings. chocolate chip Inclusions,

STANDARD RECIPES*
Dark Chocolate

| | |
|---|---|
| Cocoa butter | 35.1% |
| Cocoa liquor | 34.7% |
| Wholesweet ™/Wholesweet ™ Blends | 29.3% |
| Lecithin | 0.4% |
| Vanilla | 0.4% |

“Milk” Chocolate

| | |
|---|---|
| Cocoa butter | 23% |
| Cocoa liquor | 32% |
| Wholesweet ™/Wholesweet ™ Blends ™ | 34% |
| Rice milk powder | 10% |
| Lecithin | 0.4% |
| Vanilla | 0.4% |

*Recipe Notes: The exact recipes can change based on the product attributes desired. For example, high or lower cocoa contents can be used which would slightly alter the remaining ingredient proportions.

The term “comprising”, as used in the claims, should not be considered as being limited to the elements that are listed in context with it. It does not exclude that there are other elements or steps. It should be considered as the presence provided of these features, integers, steps or components as required, but does not preclude the presence or addition of one or more other features, integers, steps or components, or groups thereof. Thus, the volume of “an article comprising means A and B” may not be limited to an object which is composed solely of agents A and B. It means that A and B are the only elements of interest to the subject matter in connection with the present invention. In accordance with this, the terms “comprise” or “embed” enclose also the more restrictive terms “consisting essentially of” and “consist of”. By replacing “comprise” or “include” with “consist of” these terms therefore represent the basis of preferred but narrowed embodiments, which are also provided as part of the content of this document with regard to the present invention.

Unless specified otherwise, all values provided herein include up to and including the endpoints given, and the values of the constituents or components of the compositions are expressed in weight percent or % by weight of each ingredient in the composition.

As used herein, “weight percent,” “wt-%,” “percent by weight,” “% by weight,”, “ppmwt”, “ppm by weight”, “weight ppm” or “ppm” and variations thereof refer to the concentration of a substance as the weight of that substance divided by the total weight of the composition and multiplied by 100, unless specified differently. It is understood that, as used here, “percent,” “%,” are intended to be synonymous with “weight percent,” “wt-%,” etc.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

Additionally, each compound used herein may be discussed interchangeably with respect to its chemical formula, chemical name, abbreviation, etc.

### Definition of Terms

### Sugars

In the context of the present invention, the term “sugar” is a term describing the family of monosaccharides and disaccharides, with the exception of pure polyols. The term thus covers all the “conventional sugars”, the compounds that are conventionally bringing a sweet taste to food products.

The conventional sugars belong to the family of the carbohydrates. Within the context of the present invention, the term “carbohydrates” represents the family of substances with the basic formula Cₘ(H₂O)ₙ. Technically spoken, carbohydrates are hydrates of carbon, but from a structural point of view it would be more correct to regard the conventional sugars as polyhydroxy aldehydes and ketones. In biochemistry, the term of carbohydrates is regarded as a synonym for “saccharide”, a group including sugars, but also starch and cellulose, and excluding the substances having only 1 or 2 carbon atoms (for example formaldehyde CH₂O). The saccharides are subdivided into four chemical groups: monosaccharides, disaccharides, oligosaccharides, and polysaccharides. The monosaccharides and disaccharides are regarded as “sugars”, and in the present context as the “conventional sugars”. The monosaccharides are the simplest carbohydrates that cannot be hydrolysed further into smaller carbohydrates.

The conventional sugars thus belong to the family of the carbohydrates, but preferably in that context the members having only 1 or 2 carbon atoms are excluded from that family. Depending on the status of the carbonyl group, as an aldehyde or as a ketone function, one also addresses them as aldoses and ketoses. Depending on the number of carbon atoms, one calls them trioses (3), tetroses (4), pentoses (5), hexoses (6), and so on. A possible definition for the conventional sugars which dominate in food products, suitable for most practical situations but theoretically not necessarily fully correct and comprehensive, is that this term includes the total of all aldopentoses, hexopentoses, aldohexoses, ketohexose, and disaccharides of any two of these. Most of these monosaccharides may occur side by side on the one hand in an open form, and on the other hand in a closed ring form, i.e. a form whereby the aldehyde/ketone carbonyl group and a hydroxyl group have reacted to form a hemiacetal and an additional C—O—C bridge. Within each structural formula, usually in addition several stereoisomers may occur, due to the frequent presence of stereo centres, such as the carbon atoms carrying a hydroxyl function.

The term conventional sugars in particular covers the following compounds:

| Name | Formula | Mol Wt |
|---|---|---|
| Glucose (also known as dextrose) | C₆H₁₂O₆ | 180.16 |
| (5 OHs + 1 aldehyde/ether) | | |
| Fructose (5 OHs + 1 ketone/ether) | C₆H₁₂O₆ | 180.16 |
| Galactose (5 OHs + 1 aldehyde/ether) | C₆H₁₂O₆ | 180.16 |
| Tagatose (5 OHs + 1 ketone/ether) | C₆H₁₂O₆ | 180.16 |
| Lactose (8 OHs + 3 ethers) | C₁₂H₂₂O₁₁ | 342.30 |
| Maltose (8 OHs + 3 ethers) | C₁₂H₂₂O₁₁ | 342.30 |
| Isomaltose (8 OHs + 3 ethers) | C₁₂H₂₂O₁₁ | 342.30 |
| Isomaltulose (8 OHs + 3 ethers) | C₁₂H₂₂O₁₁ | 342.30 |
| Saccharose (also known as Sucrose) | C₁₂H₂₂O₁₁ | 342.30 |
| (8 OHs + 3 ethers) | | |

### Proteins

Proteins are large biomolecules, or macromolecules, consisting of one or more long chains of amino acid residues. Proteins are essential parts of living organisms and participate in virtually every process within cells.

### Dietary Fibres

Dietary fibre is the name given to the portion of plant-derived food that cannot be completely broken down by digestive enzymes. It has two main components:
Soluble fibre—which dissolves in water—is readily fermented in the colon into gases and physiologically active by-products, such as short-chain fatty acids produced in the colon by gut bacteria; it is viscous, may be called prebiotic fibre, and delays gastric emptying which, in humans, can′ result in an extended feeling of fullness.
Insoluble fibre—which does not dissolve in water—is inert to digestive enzymes in the upper gastrointestinal tract and provides bulking. Some forms of insoluble fibre, such as resistant starches, can be fermented in the colon. Bulking fibres absorb water as they move through the digestive system, easing defecation.

Food sources of dietary fibre have traditionally been divided according to whether they provide soluble or insoluble fibre. Plant foods contain both types of fibre in varying amounts, according to the plant's characteristics of viscosity and fermentability.

### Pectic Substances

In the context of the present invention, pectic substances form a family of pectic polysaccharides, rich in galacturonic acid. Most occurring is pectin, a complex set of structural heteropolysaccharide, which is contained in the primary cell walls of terrestrial plants. The amount, structure and chemical composition of pectin differs among plants, within a plant over time, and in various parts of a plant. During plant ripening, pectin is broken down by enzymes, in which process the fruit becomes softer. Higher amounts of pectin, i.e. in the range of at least 1% wt, may be found in pears, apples, guavas, quince, plums, gooseberries, carrots, apricots, sugar beets, and oranges and other citrus fruits. Citrus peels may contain as much as 30% of pectin. Smaller amounts of pectin may be found in soft fruits, like cherries, grapes and strawberries.

1. A powder comprising at least one of pulverized dried fruit and dried vegetable, the powder having an average particle size of at most 1,500 μm, wherein the powder comprises, on a dry basis, at least 30% wt and at most 70% wt of total sugars and has a moisture content of from 1 to 6% by weight.

2. The powder according to claim 1 and further comprising at least one element from the group consisting of a protein, a dietary fibre, a pectic substance, and a carbohydrate other than sugars.

3. The powder according to claim 1, wherein fructose represents at least 5% wt of the total sugars, on a dry basis.

4. The powder according to claim 1, wherein at most 80% wt of the total sugars, on a dry basis, is sucrose.

5. The powder according to claim 1, wherein the dried fruit and dried vegetable is selected from the group consisting of raisins, dried grapes, dried dates, dried pitted dates, dried figs, dried prunes, dried beets, dried carrots, dried sweet potato and dried bananas.

6. The powder according to claim 1, wherein the dried fruit or dried vegetable is sun-dried dates.

7. A chocolate product comprising a chocolate base and, on a dry basis, at least 15% wt and at most 50% wt of a powder comprising at least one of pulverized dried fruit and dried vegetable, the powder having an average particle size of at most 1,500 μm, wherein the powder comprises, on a dry basis, at least 30% wt and at most 70% wt of total sugars and has a moisture content of from 1 to 6% by weight.

8. The chocolate product according to claim 7, further comprising at least 18% wt and at most 35% wt of cocoa fat or butter.

9. The chocolate product according to claim 7, further comprising a total amount of dry matter, at least 15% wt and at most 75% wt of chocolate solids, chocolate liquor or a combination of chocolate solids and chocolate liquor.

10. The chocolate product according to claim 9, wherein the total amount of dry is at least 5% wt and at most 25% wt of at least one of a dairy milk powder and a non-dairy milk powder.

11. The chocolate product according to claim 9, further comprising a non-dairy milk powder.

12. The chocolate product according to claim 11, wherein the non-dairy milk product includes a member selected from the group consisting of soy milk, rice milk and coconut milk.

13. The chocolate product according to claim 7, wherein at least one ingredient is selected from the group consisting of an emulsifier, flavoring and particles having an average particle size in the range of at least 500 μm of a member of the group consisting of nuts, dried fruits, dried vegetables, and plant protein.

14. A process for the production of a powder comprising at least one of pulverized dried fruit and dried vegetable, the powder having an average particle size of at most 1,500 μm, wherein the powder comprises, on a dry basis, at least 30% wt and at most 70% wt of total sugars and has a moisture content of from 1 to 6% by weight, the process for the production of the powder comprising the steps of:
providing a fruit or a vegetable containing, on a dry basis, at least 40% wt and at most 70% wt of total sugars;
reducing moisture content of the fruit or vegetable to about 1% to 6% by weight to product an intermediate product; and
milling the intermediate product at a temperature in the range of 0-40° C. to obtain a powder having an average particle size of at most 100 μm.

15. The process according to claim 14, wherein the milling step is performed by vortex milling, hammer milling, roller milling, ball milling or air jet milling.

16. The process according to claim 7, further comprising the steps of:
mixing the powder with chocolate solids, chocolate liquor, or both chocolate solids and chocolate liquor to form a tempering feed, whereby chocolate particles in the chocolate solids or chocolate liquor have an average particle size of at most 1,500 μm to produce a tempering feed, and
tempering the tempering feed from step (b) to form a tempered chocolate product.

17. The process according to claim 16, further comprising the step of shaping the tempered chocolate product.

18-20. (canceled)
